(19) United States
(12) Patent Application Publication
(10) Pub. No.: US 2013/0307195 A1
(43) Pub. Date: Nov. 21, 2013

(54) CURABLE COMPOSITION FOR TRANSFER MATERIALS AND METHOD FOR FORMING MICROPATTERN USING THE CURABLE COMPOSITION

(71) Applicant: SHOWA DENKO K.K., (US)

(72) Inventors: Yoshikazu ARAI, Minato-ku (JP); Hiroshi UCHIDA, Minato-ku (JP)

(73) Assignee: SHOWA DENKO K.K., Minato-ku (JP)

(21) Appl. No.: 13/872,384

(22) Filed: Apr. 29, 2013

Related U.S. Application Data
(62) Division of application No. 12/745,473, filed on May 28, 2010, now abandoned.

(30) Foreign Application Priority Data
Nov. 30, 2007 (JP) 2007-311446
May 26, 2008 (JP) 2008-136664

(51) Int. Cl. B29D 17/00

(52) U.S. Cl. CPC B29D 17/00
USPC 264/447; 264/293

(57) ABSTRACT

The present invention has an object to provide a curable composition for transfer materials. The curable composition is applicable to a UV nanoimprint process capable of forming micropatterns with high throughput, is applicable to a thermal nanoimprint process in some cases, and is capable of forming a micropattern having high selectivity on etching rates regarding a fluorine-based gas and an oxygen gas. The curable composition for transfer materials comprises a silsesquioxane skeleton-containing compound having, in its molecule, a specific silsesquioxane skeleton and a curable functional group.

### CROSS REFERENCE TO RELATED APPLICATIONS

This is a divisional of application Ser. No. 12/745,473 filed May 28, 2010, which is a National Stage of International Application No. PCT/JP2008/070519 filed Nov. 11, 2008, the disclosure of which is incorporated herein by reference in its entirety.

### TECHNICAL FIELD

The present invention relates to a curable resin composition for transfer materials used to form a micropattern by an imprint process, and a method for forming a micropattern using the same.

### BACKGROUND ART

Nanoimprint techniques are attracting attention as micropattern-forming methods usable in semiconductor fabrication processes and processes for manufacturing magnetic recording media such as patterned media. Superior transfer materials suitable for the nanoimprint techniques are demanded.

Thermoplastic resins such as polymethyl methacrylate are used as transfer materials for nanoimprinting in some cases. In such cases, the following cycle is usually used: a cycle in which a coated material is heated up to a temperature equal to or higher than the glass transition temperature thereof, pressed with a die, cooled, and then the die is removed. There is a problem in that the cycle takes a very long time and therefore has low throughput.

Japanese Unexamined Patent Application Publication No. 2003-100609 discloses a technique in which a micropattern is obtained in such a manner that a coated film is formed on a substrate using a solution-processing material containing a solvent and a hydrogenated silsesquioxane which is one of siloxane compounds and is then pressed with a die at room temperature, the solvent is removed, and the hydrolytic curing (of the coated film) is carried out. Japanese Unexamined Patent Application Publication No. 2005-277280 discloses a technique in which a micropattern is obtained in such a manner that a coated film is formed on a substrate using a composition containing a catechol derivative and a resorcinol derivative and is then pressed with a die at room temperature.

These techniques, which are called room-temperature imprinting processes, can omit heating-cooling cycles. However, they require a long time for pressing with a die and therefore have insufficient throughput. Stampers are pressed with a high pressure and therefore have a drawback in lifetime; hence, these techniques cannot be said to be sufficient as mass-production techniques.

A technique, called UV nanoimprinting, using a photocurable resin curable with an ultraviolet ray has been proposed. In this process, a micropattern is formed in such a manner that after the photocurable resin is applied, the resin is cured by irradiation with an ultraviolet ray while a stamper is being pressed to the resin and the stamper is then removed therefrom. This process includes no heating-cooling cycle. The photocurable resin can be cured by ultraviolet ray in a very short time. The pressure applied for pressing is small. It is likely that the process can solve the above various problems.

In UV nanoimprinting however, an organic resin such as an acrylic resin is usually used. In the case of using a micropattern formed therefrom as a resist, the selectivity on etching rates regarding the types of etching gases is important. The term “selectivity on etching rates” as used herein means that the rate of etching varies depending on the types of etching gases used. The fact that the etching rate varies significantly means that selectivity on etching rates is high.

When the micropattern functions as a resist, the micropattern needs to have high resistance to a gas used in etching and also needs to be readily removed by a gas used for the removal. That is, the micropattern needs to have high selectivity on etching rates. Examples of etching gases usually used include fluorine-based gases and an oxygen gas. Generally, resins do not have significant differences in etching rates of the fluorine-based gases and the oxygen gas.

In order to increase selectivity on etching rates regarding a fluorine-based gas and an oxygen gas, a silicon compound is usually used. The hydrogenated silsesquioxane is an example of the silicon compound and is characteristic in that it is etched with a fluorine-based gas at a high rate but is etched with an oxygen gas at a very low rate. However, the hydrogenated silsesquioxane is not photocurable. Therefore, there is a problem that the hydrogenated silsesquioxane cannot be used in UV nanoimprint process.

As a method to solve the problem, Japanese Unexamined Patent Application Publication No. 2007-72374 proposes a pattern-forming method in which a silicon compound having a functional group synthesized by a sol-gel process is used. However, in this method, the molecular weight of the silicon compound cannot be increased because the increase of the molecular weight of the silicon compound by the sol-gel process causes the silicon compound to be gelled and the gelled to become insoluble in any solvent. Therefore, there is a problem that it is difficult to balance the strength and flexibility of a micropattern during and after the imprint molding.
Patent Document 1: Japanese Unexamined Patent Application Publication No. 2003-100609
Patent Document 2: Japanese Unexamined Patent Application Publication No. 2005-277280
Patent Document 3: Japanese Unexamined Patent Application Publication No. 2007-72374

### DISCLOSURE OF INVENTION

### Problems to be Solved by the Invention

The present invention has an object to provide a curable composition for transfer materials which is applicable to a UV nanoimprint process capable of forming micropatterns with high throughput, is applicable to a thermal nanoimprint process in some cases, and is capable of forming a micropattern having high selectivity on etching rates regarding a fluorine-based gas and an oxygen gas.

### Means for Solving the Problems

The inventors have made intensive studies to solve the above problems. As a result, the inventors have found that the following composition is useful in solving the problems: a curable composition comprising a silsesquioxane skeleton-containing compound having, in its molecule, a curable functional group and a silsesquioxane skeleton represented by the following formula (1).

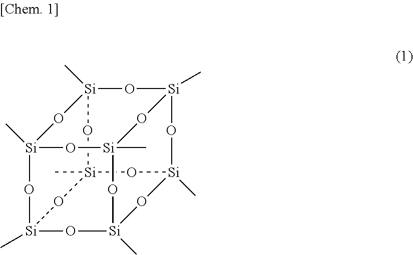

That is, the essential of the present invention is as set forth in Items [1] to [20] below.

[1] A curable composition for transfer materials used to form a micropattern, comprising a silsesquioxane skeleton-containing compound having, in its molecule, a curable functional group and a silsesquioxane skeleton represented by Formula (1) below.

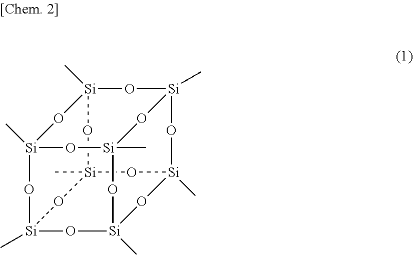

[2] The curable composition for transfer materials as described in Item (1), wherein the silsesquioxane skeleton occupies 5% or more of the molecular weight of the silsesquioxane skeleton-containing compound.

[3] The curable composition for transfer materials as described in Item [1] or [2], wherein the silsesquioxane skeleton-containing compound is produced by subjecting a cage-type silsesquioxane (A) having a Si—H group and the silsesquioxane skeleton represented by formula (1), and a compound (B) having the curable functional group and a carbon-carbon unsaturated bond other than the curable functional group to hydrosilylation reaction.

[4] The curable composition for transfer materials as described in Item [3], wherein the cage-type silsesquioxane (A) is represented by the following formula (2).

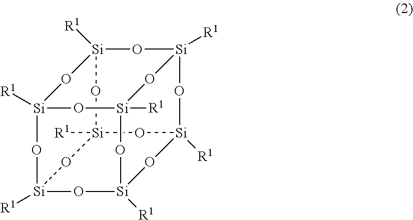

In the above formula, R¹ represents a hydrogen atom or HR²R³SiO— (R² and R³ independently represent an aromatic hydrocarbon group or an aliphatic group having 1 to 10 carbon atoms) and plural R¹ may be the same or different from each other.

[5] The curable composition for transfer materials as described in any one of Items [1] to [4], wherein the curable functional group is an active energy ray-curable functional group.

[6] The curable composition for transfer materials as described in Item [5], wherein the active energy ray-curable functional group is at least one selected from the group consisting of a (meth)acryloyl group and an epoxy group.

[7] The curable composition for transfer materials as described in Item [3] or [4], wherein the compound (B) is at least one selected from the group consisting of the following compound (a), compound (b) and compound (c).

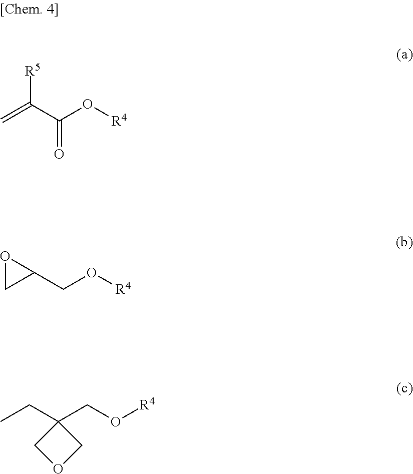

In the above formulas, R⁴ is any one of the following structures and R⁵ is hydrogen or a methyl group.

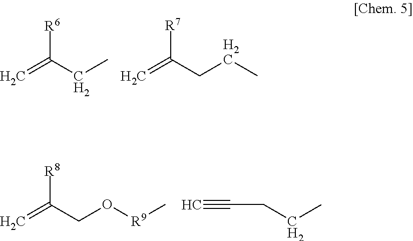

In the above formulas, R⁶ to R⁸ are hydrogen or a methyl group and R⁹ is an alkylene group having 2 to 8 carbon atoms.

[8] The curable composition for transfer materials as described in any one of Items [3] to [6], wherein the compound (B) is 1,2-epoxy-4-vinylcyclohexane.

[9] The curable composition for transfer materials as described in any one of Items [1] to [8], comprising a curing agent or a polymerization initiator.

[10] The curable composition for transfer materials as described in Item [9], wherein the curable functional group is an epoxy group and the curing agent is an acid anhydride.

[11] The curable composition for transfer materials as described in Item [6] or [7], further comprising a polythiol compound, wherein the curable functional group is a (meth)acryloyl group.

[12] The curable composition for transfer materials as described in any one of Items [6] to [8], further comprising a compound having a vinyl ether group, wherein the curable functional group is an epoxy group.

[13] The curable composition for transfer materials as described in any one of Items [1] to [12], wherein the micropattern is a micropattern with a size of 10 μm or less.

[14] A method for forming micropattern, comprising a step of applying the curable composition for transfer materials as described in any one of Items [1] to [4] on a substrate, a step of pressing a die to the curable composition for transfer materials, a step of curing the curable composition for transfer materials by heating, and a step of removing the die from the cured curable composition for transfer materials.

[15] A method for forming a micropattern, comprising a step of applying the curable composition for transfer materials as described in any one of Items [1] to [13] on a substrate, a step of pressing a die to the curable composition for transfer materials, a step of curing the curable composition by irradiation with an active energy ray, and a step of removing the die from the cured curable composition for transfer materials.

[16] The micropattern-forming method as described in Item [15], wherein the active energy ray is irradiated in a direction from the die to a coated film of the curable composition for transfer materials.

[17] The micropattern-forming method as described in Item [15], wherein the substrate is a transparent substrate and the active energy ray is irradiated in a direction from the transparent substrate to a coated film of the curable composition for transfer materials.

[18] A method for manufacturing a finely patterned magnetic recording medium, wherein the substrate comprises a base and a magnetic film disposed thereon and the magnetic film is partly removed or demagnetized using a micropattern formed by the method as described in any one of Items [14] to [17].

[19] A magnetic recording medium obtained by the method as described in Item [18].

[20] A magnetic recording/reproducing device equipped with the magnetic recording medium as described in Item [19].

### Advantages

A curable composition for transfer materials according to the present invention is useful in forming a micropattern having high selectivity on etching rates regarding a fluorine-based gas and an oxygen gas with high throughput.

A micropattern-forming method according to the present invention uses the curable composition for transfer materials and has the following three features:

(1) transfer performance during imprinting is good;

(2) a cured film can be readily removed by reactive ion etching using a fluorine-based gas during bottom blanking performed to expose a magnetic layer after imprinting or during the peeling of the cured film, the cured film being formed from the composition; and

(3) the curable composition has, as a resist, good resistance to etching such as oxygen etching and Ar milling, performed to process a media.

A micropattern for use in semiconductor and magnetic recording medium-manufacturing processes can be prepared by using the micropattern-forming method according to the present invention.

### BRIEF DESCRIPTION OF DRAWINGS

FIG. 1 is an illustration showing steps of a method for forming a micropattern with a size of 10 μm or less using a curable composition for transfer materials according to the present invention.

FIG. 2 is an illustration of a disk which is used in Example 2, which is made of quartz glass and which has been patterned with a concave and convex shape along the radial direction. The disk has a diameter of 1.8 inches. The concave part has a width (L) of 80 nm in the radial direction in the figure and a depth of 150 nm. The convex part has a width (S) of 120 nm in the radial direction in the figure. A rectangle corresponding to a die on a circular glass substrate shown on the right side of the substrate shown in FIG. 2 has a vertical (lateral) length of 0.1 mm.

FIG. 3 is a field emission electron micrograph of a cross section of a glass substrate which carries a thin film having a transferred pattern and which has been broken in Example 2.

FIG. 4 is an illustration showing a bottom-blanking step for processing a magnetic film in a magnetic recording medium.

FIG. 5 is a schematic view showing the partial removal or demagnetization of a magnetic film in a magnetic recording medium.

### EXPLANATION OF REFERENCE

12 die
14 coated film consisting of a curable composition for transfer materials according to the present invention
16 substrate
20 micropattern made of a curable composition
22 magnetic film
24 base
26 non-magnetic layer

### BEST MODES FOR CARRYING OUT THE INVENTION

A curable composition for transfer materials according to the present invention and a method for forming a micropattern using the composition will now be described in detail below.

### [Curable Composition for Transfer Materials]

The curable composition for transfer materials according to the present invention (hereinafter simply referred to as “curable composition”) comprises a silsesquioxane skeleton-containing compound having, in its molecule, a curable functional group and a silsesquioxane skeleton represented by the following formula (1) (hereinafter simply referred to as “silsesquioxane skeleton-containing compound”).

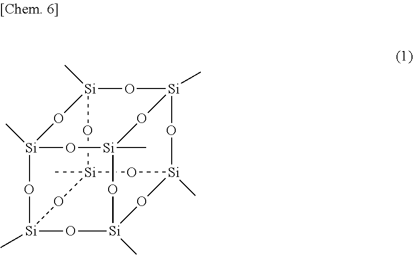

In the curable composition according to the present invention, the silsesquioxane skeleton which is represented by the formula (1) preferably occupies 5% or more and more preferably 8% to 65% of the molecular weight of the silsesquioxane skeleton-containing compound. When less than 5%, a resist obtained from the curable composition sometimes has low resistance to oxygen etching. On the other hand, when the percentage of the silsesquioxane skeleton which is represented by the formula (1) is excessively large, the solubility of the curable composition into a solvent is low and therefore a resist solution is difficult to handle, the composition has a higher viscosity as compared to that having the same concentration, and tends to have a low curing rate.

The calculation of the percentage (%) of the silsesquioxane skeleton which is represented by the formula (1) in the silsesquioxane skeleton-containing compound is as described below.

Since the formula weight of the formula (1) is 416.7 and, for example, the silsesquioxane skeleton-containing compound which is obtained by the reaction of 1 mol of octakis(dimethylsilyloxy)silsesquioxane with 8 mol of allyl methacrylate, has a molecular weight of 2,027.2. therefore, the percentage is:

416.7/2,027.2=20.6%.

The silsesquioxane skeleton-containing compound can be produced by subjecting a cage-type silsesquioxane (A) having a Si—H group and the silsesquioxane skeleton represented by the formula (1) and a compound (B) having the curable functional group and a carbon-carbon unsaturated bond other than the curable functional group to a hydrosilylation reaction.

### <Cage-Type Silsesquioxane (A)>

An example of the cage-type silsesquioxane (A) is a compound, represented by the following formula (2), having a Si—H group in its molecule.

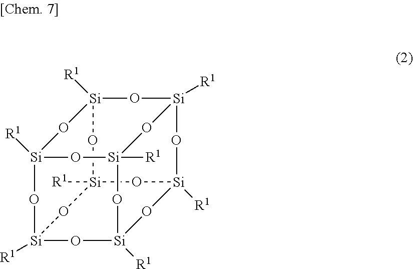

In the above formula (2), R¹ represents a hydrogen atom or HR²R³SiO—. R² and R³ independently represent an aromatic hydrocarbon group or an aliphatic group having 1 to 10 carbon atoms. The aromatic hydrocarbon group usually has 6 to 14 carbon atoms. Plural R¹ may be the same or different from each other.

The silsesquioxane skeleton-containing compound can be synthesized by the reaction of the cage-type silsesquioxane (A) with a compound (compound (B)) which has a carbon-carbon unsaturated bond that can be hydrosilylated with the Si—H group of the silsesquioxane and which additionally has a curable functional group.

Specific examples of the cage-type silsesquioxane (A) which is represented by the formula (2) include octakis(dimethylsilyloxy)silsesquioxane, octakis(methylphenylsilyloxy)silsesquioxane, octakis(dimethylphenylsilyloxy)silsesquioxane, uni(trimethylsilyloxy)heptakis(dimethylsilyloxy)silsesquioxane, bis(trimethylsilyloxy)hexakis(dimethylsilyloxy)silsesquioxane, tris(trimethylsilyloxy)pentakis(dimethylsilyloxy)silsesquioxane, tetrakis(trimethylsilyloxy)tetrakis(dimethylsilyloxy)silsesquioxane, pentakis(trimethylsilyloxy)tris(dimethylsilyloxy)silsesquioxane, hexakis(trimethylsilyloxy)bis(dimethylsilyloxy)silsesquioxane, heptakis(trimethylsilyloxy)uni(dimethylsilyloxy)silsesquioxane and hydrogenated silsesquioxane.

Among these compounds, for example, a hydrogenated silsesquioxane can be synthesized by hydrolysis of trichlorosilane in the presence of an iron chloride catalyst using a process disclosed in Inorg. Chem., 30, 2707 (1991). Further, an octakis(substituted silyloxy)silsesquioxane can be synthesized by the reaction of the tetramethylammonium salt of Si₈O₂₀⁸⁻ with a chlorinated alkyl-substituted silicon compound such as dimethylchlorosilane, methylphenylchlorosilane, diphenylchlorosilane or trimethylchlorosilane using a process disclosed in J. Organomet. Chem., 441, 373 (1992).

### <Compound (B)>

Examples of the carbon-carbon unsaturated bond that can be hydrosilylated with the Si—H group include a vinyl group, an allyl group, an isopropenyl group and a propargyl group.

The curable functional group in the silsesquioxane skeleton-containing compound is a curable functional group which becomes reactable by an active energy ray or heat and is preferably a (meth)acryloyl or epoxy group which becomes reactable by the active energy ray. The term “epoxy group” as used herein means a group having a triangular structure in which two carbon atoms directly bonded to each other are linked by an oxygen atom and also means a group having a structure in which two carbon atoms directly bonded to each other or indirectly bonded to each other through other atom (principally a carbon atom) are linked by an oxygen atom. Therefore, the term “epoxy group” as used herein covers a glycidyl group, an oxetanyl group and a cyclohexene oxide group.

Examples of the compound having both of these functional groups in its molecule, that is, the compound (compound (B)) having the curable functional group and the carbon-carbon unsaturated bond other than the curable functional group include compounds having an epoxy group and an allyl group such as allyl glycidyl ether, 1,2-epoxy-4-vinylcyclohexane and allyl 3,4-epoxycyclohexanecarboxylate; compounds having a (meth)acryloyl group and an allyl group such as allyl (meth)acrylate, ethylene glycol monoallyl ether (meth)acrylate, diethylene glycol monoallyl ether (meth)acrylate, propylene glycol monoallyl ether (meth)acrylate and dipropylene glycol monoallyl ether (meth)acrylate; and

compounds such as propargyl (meth)acrylate and allyl ether of 3-ethyl-3-hydroxymethyloxetane.

The compound (B) is preferably a compound which has a (meth)acryloyl group or an epoxy group such as a cyclohexene oxide group that can be cured with an active energy ray.

Other specific examples of the compound (B) include compounds (a) to (c) represented by the following structural formulas.

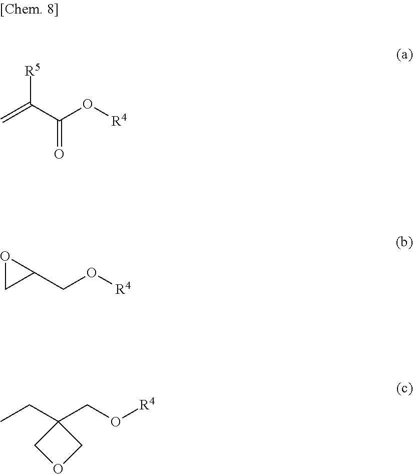

In the above formulas, R⁴ is any one of structures depicted below and R⁵ is hydrogen or a methyl group.

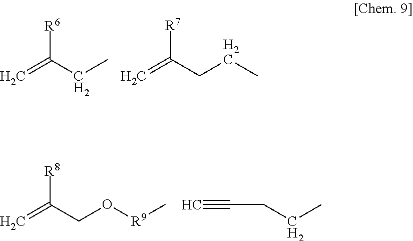

In the above formulas, R⁶ to R⁸ are hydrogen or a methyl group and R⁹ is an alkylene group having 2 to 8 carbon atoms.

### <Process for Producing Silsesquioxane Skeleton-Containing Compound>

The silsesquioxane skeleton-containing compound having the curable functional group of the present application is produced by bonding the cage-type silsesquioxane (A) having the Si—H group and the silsesquioxane skeleton specified above and the compound (B) having the curable functional group and the carbon-carbon unsaturated bond other than the curable functional group, through the hydrosilylation reaction.

A general hydrosilylation reaction is described below.

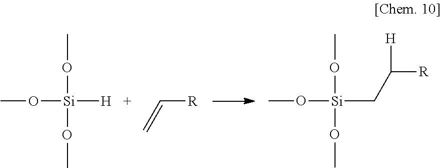

The reaction of, for example, octakis(dimethylsilyloxy)silsesquioxane represented by the following formula (d) as the cage-type silsesquioxane (A) with allyl methacrylate represented by the following formula (e) as the compound (B), principally produces a compound having a structure represented by the following formula (f).

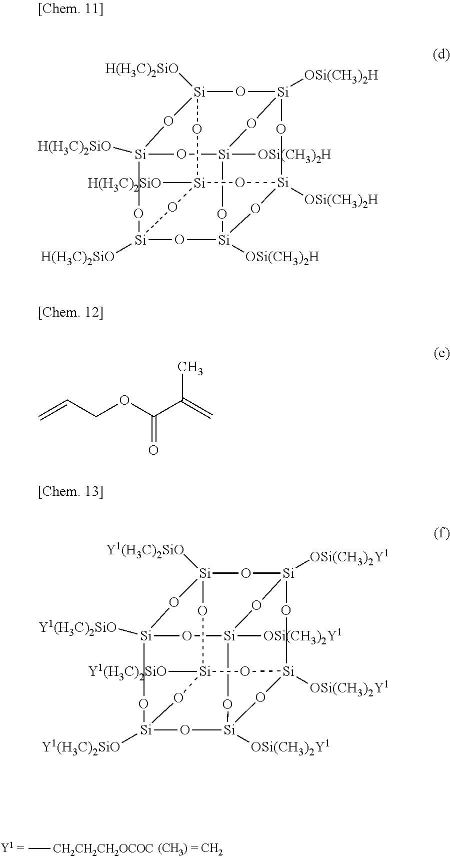

The silsesquioxane skeleton-containing compound having the curable functional group of the present application can be produced by the above process, that is, the reaction of the cage-type silsesquioxane (A) with the compound (B). The following compound can be partially used instead of the compound (B) as long as a subsequent curing reaction is not affected: a compound having only a carbon-carbon double bond reactable with —Si—H.

Examples of this compound include allyl alcohol, 1-pentene, 1-hexene, 1-octene, styrene and vinyl toluene.

Although attention needs to be paid to gelation, a small amount of a compound having a plurality of unsaturated groups can be used as the compound having only the carbon-carbon double bond.

Examples of these compounds include diallyl ether, dimethyldivinylsilane, divinylmethylphenylsilane, diphenyldivinylsilane, 1,4-bis(dimethylvinylsilyl)benzene, 1,1,3,3-tetraphenyldivinylsiloxane, 1,3-divinyl-1,1,3,3-tetramethyldisiloxane, 1,3-bis(dimethylvinylsiloxy)benzene, 1,4-bis(dimethylvinylsiloxy)benzene and tetravinylsilane.

The amount of each of these compounds used should be adjusted to be less than or equal to a molar ratio at which no gel is formed by the reaction of these compounds with a polyfunctional hydrogenated silsesquioxane.

A Si—H group-having compound other than the cage-type silsesquioxane (A) having the Si—H group and the silsesquioxane skeleton specified above can be used to produce the silsesquioxane skeleton-containing compound in combination with the silsesquioxane as long as the selectivity on etching rates of the cured product of the curable composition is not deteriorated.

As examples of such compounds, mention may be made of compounds having 2 or more hydrogen groups on a silicon atom including monoalkylsilanes such as phenylsilane, dialkylsilanes such as diphenylsilane and methylphenylsilane, and polyhydrogen siloxane compounds represented by the following general formulas.

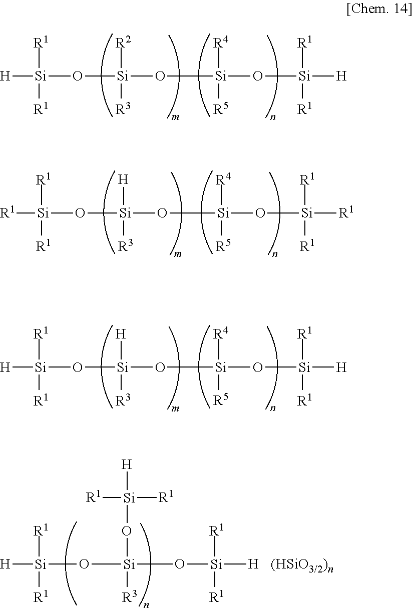

In the above formulas, R¹ represents an alkyl group having 1 to 5 carbon atoms, R² to R⁵ each represents an alkyl having 1 to 8 carbon atoms or phenyl group, (HSiO_{3/2})ₙ represents a cage-type silsesquioxane and a ladder-type silsesquioxane, and m and n independently represent an integer of 1 to 500.

When a hydrosilylation reaction is carried out to produce the silsesquioxane skeleton-containing compound, the ratio of the cage-type silsesquioxane (A) to the compound (B) used is preferably set such that the number of the carbon-carbon unsaturated bond which is reactable with the Si—H group is greater than that of the Si—H group. In particular, the molar ratio of the carbon-carbon unsaturated bond/the Si—H group is preferably 1.0 or more, more preferably 1.02 to 10 and still more preferably 1.1 to 2.5.

The following procedure of the reaction is preferred: a procedure in which the compound (B) is allowed to react with the cage-type silsesquioxane (A) in advance and the compound which has no curable functional group but the carbon-carbon double bond only and which has a low boiling point is then allowed to react with the silsesquioxane. This is because an excessive amount of the compound having the carbon-carbon double bond only is readily removed by distillation or the like.

The curable composition for transfer materials may be subjected to a micropattern-transferring step while the compound (B) remains in the composition.

A catalyst is preferably used during carrying out the hydrosilylation reaction. Examples of a catalyst for such addition reaction include a platinum catalyst, a rhodium catalyst, a palladium catalyst and a ruthenium catalyst. The platinum catalyst is more preferred. Examples of the platinum catalyst include chloroplatinic acid, products from the reaction of chloroplatinic acid with an alcohol, products from the reaction of chloroplatinic acid with an olefin, products from the reaction of chloroplatinic acid with a vinyl group-containing siloxane, platinum-olefin complexes, platinum vinyl group-containing siloxane complexes and platinum carbonyl complexes. They are preferably used while being dissolved or dispersed in a solvent.

Specifically, a 2% solution (produced by GELEST INC.) of a platinum-divinyltetramethyldisiloxane complex in xylene is preferably used.

The amount of the addition reaction catalyst used is not particularly limited and should be sufficient amount for the reaction. Specifically, the amount in terms of a metal element component such as platinum is preferably 0.01 to 10,000 ppm and more preferably 0.1 to 1,000 ppm of the sum of the amounts of raw materials used to carry out the hydrosilylation reaction, that is, the sum of the amount of the cage-type silsesquioxane (A) and that of the compound (B), in some cases, in addition to those, that of the compound having only the carbon-carbon double bond reactable with —Si—H other than the compound (B) and that of the Si—H group-having compound other than the cage-type silsesquioxane (A) on a mass basis.

The reaction temperature of the hydrosilylation reaction is usually 0° C. to 250° C. In order to prevent the polymerization reaction of a functional group serving as the curable functional group of the silsesquioxane skeleton-containing compound, the temperature is preferably 0° C. to 100° C. The rate of the reaction can be low depending on a raw material system. In such a case, it is preferable to carry out heating to 40° C. or higher. In the case of heating is carried out, a polymerization inhibitor suitable for the curable functional group is preferably added to a reaction system.

Since moisture can cause the reaction to be unstable, the reaction may be carried out under an argon or nitrogen atmosphere as required.

The reaction is highly thermogenic and therefore a reaction solvent may be used as required. Useable examples of the reaction solvents include aromatic hydrocarbon solvents such as toluene and xylene; aliphatic hydrocarbon solvents such as hexane and octane; ketone solvents such as methyl ethyl ketone and methyl isobutyl ketone; ester solvents such as ethyl acetate, isobutyl acetate and propylene glycol monomethyl ether acetate; ether solvents such as diisopropyl ether and 1,4-dioxane; alcohol solvents such as isopropanol propylene glycol mono-n-propyl ether and ethylene glycol monoethyl ether; and mixed solvents thereof.

Among them, an aromatic hydrocarbon solvent or an aliphatic hydrocarbon solvent is preferable. Further, a cyano group-containing compound can be used as the reaction solvent.

### <Other Components of the Curable Composition for Transfer Materials>

When the curable functional group in the silsesquioxane skeleton-containing compound which is contained in the curable composition for transfer materials according to the present invention is a (meth)acryloyl group, radical polymerization of silsesquioxane skeleton-containing compound alone or and a compound having a functional group copolymerizable with a (meth)acryloyl group, or radical polymerization using polyaddition with a polythiol in combination can be carried out.

When the curable functional group is an epoxy group, cationic polymerization of the silsesquioxane skeleton-containing compound alone or and a compound having a functional group copolymerizable with an epoxy group such as a vinyl ether group, or polymerization such as polyaddition using an acid anhydride as a curing agent can be carried out.

When the curable functional group in the silsesquioxane skeleton-containing compound is a (meth)acryloyl group, the curing rate of the curable composition for transfer materials according to the present invention can be adjusted in a step of curing the curable composition for transfer materials according to the present invention by a process below described if radical polymerization is carried out under co-presence of the silsesquioxane skeleton-containing compound and other compound having a functional group copolymerizable with a (meth)acryloyl group.

Examples of the compound having the functional group copolymerizable with the (meth)acryloyl group include a compound having a (meth)acryloyl group, a styryl group, a vinyl group, an allyl group, a maleyl group, a fumaryl group or the like. In particular, a compound having a (meth)acryloyl group is preferred. A monomer or oligomer having one or more (meth)acrylate structures is preferably used.

As the monomer or oligomer having one or more (meth)acrylate structures, monofunctional or polyfunctional (meth)acrylates can be use. Examples thereof include methyl (meth)acrylate, ethyl (meth)acrylate, n-propyl (meth)acrylate, isopropyl (meth)acrylate, n-butyl (meth)acrylate, isobutyl (meth)acrylate, sec-butyl (meth)acrylate, hexyl (meth)acrylate, octyl (meth)acrylate, 2-ethylhexyl (meth)acrylate, decyl (meth)acrylate, isobornyl (meth)acrylate, cyclohexyl (meth)acrylate, phenyl (meth)acrylate, benzyl (meth)acrylate, 2-hydroxyethyl (meth)acrylate, 2-hydroxypropyl (meth)acrylate, 3-hydroxypropyl (meth)acrylate, 2-hydroxybutyl (meth)acrylate, 2-hydroxyphenylethyl (meth)acrylate, ethylene glycol di(meth)acrylate, propylene glycol di(meth)acrylate, 1,4-butanediol di(meth)acrylate, diethylene glycol di(meth)acrylate, triethylene glycol di(meth)acrylate, trimethylolpropane di(meth)acrylate, trimethylolpropane tri(meth)acrylate, pentaerythritol penta(meth)acrylate, N,N-dimethyl(meth)acrylamide, N,N-diethyl(meth)acrylamide and N-acryloyl morpholine.

Further examples of the compounds having the (meth)acryloyl group-copolymerizable functional group include what is called an epoxy acrylate obtained by adding (meth)acrylic acid to an epoxy resin such as a bisphenol-A type epoxy resin, a hydrogenated bisphenol-A type epoxy resin, a brominated bisphenol-A type epoxy resin, a bisphenol-F type epoxy resin, a novolak type epoxy resin, a phenol novolak type epoxy resin, a cresol novolak type epoxy resin, an alicyclic epoxy resin, an N-glycidyl type epoxy resin, a bisphenol-A novolak type epoxy resin, a chelate-type epoxy resin, a glyoxal-type epoxy resin, an amino group-containing epoxy resin, a rubber-modified epoxy resin, a dicyclopentadiene phenolic type epoxy resin, a silicone-modified epoxy resin and an ε-caprolactone-modified epoxy resin.

Other examples of the compounds having the (meth)acryloyl group-copolymerizable functional group include, polyisocyanate compounds such as 2,4- or 2,6-tolylene diisocyanate, m- or p-xylylene diisocyanate, hydrogenated xylylene diisocyanates, diphenylmethane-4,4′-diisocyanate, modification product or polymerization product thereof, hexamethylene diisocyanate, isophorone diisocyanate, 1,4-tetramethylene diisocyanate and naphthalene diisocyanates; urethane acrylates which are obtained by reacting with active hydrogen-containing (meth)acrylate monomers such as 2-hydroxyethyl (meth)acrylate, 2-hydroxypropyl (meth)acrylate, tripropylene glycol (meth)acrylate, 1,4-butylene glycol mono(meth)acrylate, 2-hydroxy-3-chloroypropyl (meth)acrylate, glycerol mono(meth)acrylate, glycerol di(meth)acrylate, glycerol methacrylate acrylate, trimethylolpropane di(meth)acrylate, pentaerythritol tri(meth)acrylate or the like;

styrene and its derivatives such as styrene, 2,4-dimethyl-α-methylstyrene, o-methylstyrene, m-methylstyrene, p-methylstyrene, 2,4-dimethylstyrene, 2,5-dimethylstyrene, 2,6-dimethylstyrene, 3,4-dimethylstyrene, 3,5-dimethylstyrene, 2,4,6-trimethylstyrene, 2,4,5-trimethylstyrene, pentamethylstyrene, o-ethylstyrene, m-ethylstyrene, p-ethylstyrene, o-chlorostyrene, m-chlorostyrene, p-chlorostyrene, o-bromostyrene, m-bromostyrene, p-bromostyrene, o-methoxystyrene, m-methoxystyrene, p-methoxystyrene, o-hydroxystyrene, m-hydroxystyrene, p-hydroxystyrene, 2-vinylbiphenyl, 3-vinylbiphenyl, 4-vinylbiphenyl, 1-vinylnaphthalene, 2-vinylnaphthalene, 4-vinyl-p-terphenyl, 1-vinylanthracene, α-methylstyrene, o-isopropenyltoluene, m-isopropenyltoluene, p-isopropenyltoluene, 2,4-dimethyl-α-methylstyrene, 2,3-dimethyl-α-methylstyrene, 3,5-dimethyl-α-methylstyrene, p-isopropyl-α-methylstyrene, α-ethylstyrene, α-chlorostyrene, divinylbenzene, divinylbiphenyl and diisopropylbenzene;
(meth)acrylonitriles and their derivatives such as acrylonitrile and methacrylonitrile;
vinyl esters of organic carboxylic acids and their derivatives such as vinyl acetate, vinyl propionate, vinyl butyrate, vinyl benzoate and divinyl adipate;
allyl ester of organic carboxylic acids and their derivatives such as allyl acetate, allyl benzoate, diallyl adipate, diallyl terephthalate, diallyl isophthalate and diallyl phthalate;
dialkyl fumarates and their derivatives such as dimethyl fumarate, diethyl fumarate, diisopropyl fumarate, di-sec-butyl fumarate, diisobutyl fumarate, di-n-butyl fumarate, di-2-ethylhexyl fumarate and dibenzyl fumarate;
dialkyl maleates and their derivatives such as dimethyl maleate, diethyl maleate, diisopropyl maleate, di-sec-butyl maleate, diisobutyl maleate, di-n-butyl maleate, di-2-ethylhexyl maleate and dibenzyl maleate;
dialkyl itaconates and their derivatives such as dimethyl itaconate, diethyl itaconate, diisopropyl itaconate, di-sec-butyl itaconate, diisobutyl itaconate, di-n-butyl itaconate, di-2-ethylhexyl itaconate and dibenzyl itaconate;
N-vinylamide derivatives derived from organic carboxylic acids such as N-methyl-N-vinylacetamide;
maleimides and their derivatives such as N-phenylmaleimide and N-cyclohexylmaleimide.

When the curable functional group in the silsesquioxane skeleton-containing compound which is contained in the curable composition for transfer materials according to the present invention is a (meth)acryloyl group, the radical polymerization using the polyaddition with the polythiol can be carried out as described above. Examples of a polythiol compound that can be used in the radical polymerization using the polyaddition with the polythiol include 2,2-bis(mercaptomethyl)-1,3-propanedithiol, bis(2-mercaptoethyl)ether, ethylene glycol bis(2-mercaptoacetate), ethylene glycol bis(3-mercaptopropionate), trimethylolpropane-tris-(β-thiopropionate), tris-2-hydroxyethyl-isocyanurate tris-β-mercaptopropionate, pentaerythritol tetrakis(β-thiopropionate), 1,8-dimercapto-3,6-dioxaoctane, 1,2,3-trimercaptobenzene, 1,2,4-trimercaptobenzene, 1,3,5-trimercaptobenzene, 1,2,3-tris(mercaptomethyl)benzene, 1,2,4-tris(mercaptomethyl)benzene and 1,3,5-tris(mercaptomethyl)benzene.

When the curable functional group in the silsesquioxane skeleton-containing compound is an epoxy group, the curing rate of the curable composition for transfer materials according to the present invention can be adjusted in a step of curing the curable composition for transfer materials according to the present invention by a process below if a cation polymerization is carried out in the co-presence of another compound having a functional group copolymerizable with an epoxy group in addition to silsesquioxane skeleton-containing compound.

Examples of the compounds having the epoxy group-copolymerizable functional group include vinyl ether group-containing compounds. Examples thereof include triethylene glycol divinyl ether, tetraethylene glycol divinyl ether, trimethylolpropane trivinyl ether, cyclohexane-1,4-dimethylol divinyl ether, 1,4-butanediol divinyl ether, polyester divinyl ether and polyurethane polyvinyl ether.

Other examples of the compounds having the epoxy group-copolymerizable functional group include epoxy compounds having 2 or more epoxy groups in a molecule such as a bisphenol-A type epoxy resin, a hydrogenated bisphenol-A type epoxy resin, a brominated bisphenol-A type epoxy resin, a bisphenol-F type epoxy resin, a novolak type epoxy resin, a phenol novolak type epoxy resin, a cresol novolak type epoxy resin, a biphenyl type epoxy resin, a polyfunctional type epoxy resin, an amine type epoxy resin, a heterocyclic ring-containing epoxy resin, an alicyclic epoxy resin, an N-glycidyl type epoxy resin, a bisphenol-A novolak type epoxy resin, a chelate-type epoxy resin, a glyoxal type epoxy resin, a rubber-modified epoxy resin, a dicyclopentadiene phenolic type epoxy resin, a silicone-modified epoxy resin and an ε-caprolactone-modified epoxy resin.

Specific examples thereof include commercial products, EPICOAT 828, EPICOAT 1002 and EPICOAT 1004, produced by Japan Epoxy Resins Co., Ltd.;

commercial products, EPICOAT 806, EPICOAT 807 and EPICOAT 4005P, produced by Japan Epoxy Resins Co., Ltd. and a commercial product, YDF-170, produced by Tohto Kasei Co., Ltd.;
commercial products, EPICOAT 152 and EPICOAT 154, produced by Japan Epoxy Resins Co., Ltd. and a commercial product, EPPN-201, produced by Nippon Kayaku Co., Ltd.;
commercial products, EOCN-125S, EOCN-103S and EOCN-104S, produced by Nippon Kayaku Co., Ltd.;
commercial products, EPICOAT YX-4000 and EPICOAT YL-6640, produced by Japan Epoxy Resins Co., Ltd.; a commercial product, EPICOAT 1031S, produced by Japan Epoxy Resins Co., Ltd., a commercial product, ARALDITE 0163, produced by Ciba Specialty Chemicals Inc. and commercial products, DENACOL EX-611, DENACOL EX-614, DENACOL EX-614B, DENACOL EX-622, DENACOL EX-512, DENACOL EX-521, DENACOL EX-421, DENACOL E-411 and DENACOL EX-321, produced by Nagase ChemteX Corporation;
a commercial product, EPICOAT 604, produced by Japan Epoxy Resins Co., Ltd., a commercial product, YH-434, produced by Tohto Kasei Co., Ltd., commercial products, TETRAD-X and TETRAD-C, produced by Mitsubishi Gas Chemical Company, Inc.,
a commercial product, GAN, produced by Nippon Kayaku Co., Ltd. and a commercial product, ELM-120, produced by Sumitomo Chemical Co., Ltd.;
a commercial product, Araldite PT810, produced by Ciba Specialty Chemicals Inc.;
commercial products, EHPE 3150, EHPE 3150CE, CELLOXIDE 2000, CELLOXIDE 2021, CELLOXIDE 2081, EPOLEAD PB3600 and EPOLEAD GT401, produced by Daicel Chemical Industries Ltd.; and epoxidated polybutadienes such as EPOLEAD PB3600, produced by Daicel Chemical Industries Ltd. These products may be used alone or in combination of 2 or more kinds thereof.

A compound having an oxetanyl group can be used.

Examples thereof include 1,3-bis[(3-ethyl-3-oxetanylmethoxy)methyl]propane, ethylene glycol bis(3-ethyl-3-oxetanylmethyl)ether, trimethylolpropane tris(3-ethyl-3-oxetanylmethyl)ether, pentaerythritol tetrakis(3-ethyl-3-oxetanylmethyl)ether, dipentaerythritol hexakis(3-ethyl-3-oxetanylmethyl)ether and 2-ethyl-2-hydroxymethyloxetane.

When the curable functional group is an epoxy group, particularly a glycidyl group, an acid anhydride can be used as a curing agent for curing by polyaddition. Examples of the acid anhydride include aromatic acid anhydrides such as phthalic anhydride, trimellitic anhydride and pyromellitic anhydride and cyclic aliphatic anhydrides such as tetrahydrophthalic anhydride, methyltetrahydrophthalic anhydride, hexahydrophthalic anhydride and methylhexahydrophthalic anhydride.

The amount of the acid anhydride used is usually 0.7 to 1.2 equivalents and preferably 0.8 to 1.1 equivalents based on the epoxy group. Furthermore, a curing accelerator such as an imidazole, tertiary amine and organic phosphine compound can be used.

There are two processes for curing the curable composition according to the present invention: energy ray curing and heat curing. For the above radical or cationic polymerization, it is preferable to add a polymerization initiator suitable for respective curing processes according to necessity.

When the curable functional group is a (meth)acryloyl group and the curable composition contains the polythiol compound, a radical polymerization initiator is preferably used.

Examples of a thermal radical polymerization initiator used for thermal polymerization include organic peroxides such as methyl ethyl ketone peroxide, cyclohexanone peroxide, methylcyclohexanone peroxide, methyl acetate peroxide, acetyl acetate peroxide, 1,1-bis(t-butylperoxy)butane, 1,1-bis(t-butylperoxy)-cyclohexane, 1,1-bis(t-butylperoxy)-2-methylcyclohexane, 1,1-bis(t-butylperoxy)-3,3,5-trimethylcyclohexane, 1,1-bis(t-butylperoxy)cyclododecane, 1,1-bis(t-hexylperoxy)-cyclohexane, 1,1-bis(t-hexylperoxy)-3,3,5-trimethylcyclohexane, 2,2-bis(4,4-di-t-butylperoxycyclohexyl)propane, t-butyl hydroperoxide, t-hexyl hydroperoxide, 1,1,3,3-tetramethylbutyl hydroperoxide, cumene hydroperoxide, p-methyl hydroperoxide, diisopropylbenzene hydroperoxide, di-t-butyl peroxide, dicumyl peroxide, t-butylcumyl peroxide, α,α′-bis(t-butylperoxy)diisopropylbenzene, 2,5-dimethyl-2,5-bis(t-butylperoxy)hexane, 2,5-dimethyl-2,5-bis(t-butylperoxy)hexyne-3, isobutyryl peroxide, 3,3,5-trimethylhexanoyl peroxide, octanoyl peroxide, lauroyl peroxide, stearoyl peroxide, succinic acid peroxide, m-toloylbenzoyl peroxide, benzoyl peroxide, di-n-propyl peroxydicarbonate, diisopropyl peroxydicarbonate, bis(4-t-butylcyclohexyl)peroxydicarbonate, di-2-ethoxyethyl peroxydicarbonate, di-2-ethoxyhexyl peroxydicarbonate, di-3-methoxybutyl peroxydicarbonate, di-S-butyl peroxydicarbonate, di(3-methyl-3-methoxybutyl)peroxydicarbonate, α,α′-bis(neodecanoylperoxy)diisopropylbenzene, t-butyl peroxyneodecanoate, t-hexyl peroxyneodecanoate, 1,1,3,3-tetramethylbutyl peroxyneodecanoate, 1-cyclohexyl-1-methylethyl peroxyneodecanoate, cumyl peroxyneodecanoate, t-butyl peroxypivalate, t-hexyl peroxypivalate, t-butyl peroxy-2-ethylhexanoate, t-hexyl peroxy-2-ethylhexanoate, 1,1,3,3-tetramethylbutyl peroxy-2-ethylhexanoate, 2,5-dimethyl-2,5-bis(2-ethylhexanoylperoxy)hexane, 1-cyclohexyl-1-methylethyl peroxy-2-ethylhexanoate, t-butyl peroxy-3,5,5-trimethylhexanoate, t-butylperoxyisopropyl monocarbonate, t-hexylperoxyisopropyl monocarbonate, t-butylperoxy-2-ethylhexyl monocarbonate, t-butylperoxyallyl monocarbonate, t-butyl peroxyisobutyrate, t-butyl peroxymaleate, t-butyl peroxybenzoate, t-hexyl peroxybenzoate, t-butyl peroxy-m-toluoylbenzoate, t-butyl peroxylaurate, t-butyl peroxyacetate, bis(t-butylperoxy)isophthalate, 2,5-dimethyl-2,5-bis(m-toluoylperoxy)hexane, 2,5-dimethyl-2,5-bis(benzoylperoxy)hexane, t-butyl trimethylsilyl peroxide, 3,3′,4,4′-tetra(t-butylperoxycarbonyl)benzophenone and 2,3-dimethyl-2,3-diphenylbutane, and

azo compounds such as 1-[(1-cyano-1-methylethyl)azo]formamide, 1,1′-azobis(cyclohexane-1-carbonitrile), 2,2′-azobis(2-methylbutyronitrile), 2,2′-azobisisobutyronitrile, 2,2′-azobis(2,4-dimethyl-4-methoxyvaleronitrile), 2,2′-azobis(2,4-dimethylvaleronitrile), 2-phenylazo-4-methoxy-2,4-dimethylvaleronitrile, 2,2′-azobis(2-methylpropionamidine)dihydrochloride, 2,2′-azobis(2-methyl-N-phenylpropionamidine)dihydrochloride, 2,2′-azobis[N-(4-chlorophenyl)-2-methylpropionamidine]dihydrochloride, 2,2′-azobis[N-(4-hydrophenyl)-2-methylpropionamidine]dihydrochloride, 2,2′-azobis[2-methyl-N-(2-propenyl)propionamidine]dihydrochloride, 2,2′-azobis[N-(2-hydroxyethyl)-2-methylpropionamidine]dihydrochloride, 2,2′-azobis[2-methyl-N-(phenylmethyl)propionamidine]dihydrochloride, 2,2′-azobis[2-(2-imidazoline-2-yl)propane]dihydrochloride, 2,2′-azobis[2-(2-imidazoline-2-yl)propane]dihydrochloride, 2,2′-azobis[2-(5-methyl-2-imidazoline-2-yl)propane]dihydrochloride, 2,2′-azobis{2-[1-(2-hydroxyethyl)-2-imidazoline-2-yl]propane}dihydrochloride, 2,2′-azobis[2-(4,5,6,7-tetrahydro-1H-1,3-diazepine-2-yl)propane]dihydrochloride, 2,2′-azobis[2-(3,4,5,6-tetrahydropyrimidine-2-yl)propane]dihydrochloride, 2,2′-azobis[2-(5-hydroxy-3,4,5,6-tetrahydropyrimidine-2-yl)propane]dihydrochloride, 2,2′-azobis(2-methylpropionamide), 2,2′-azobis[2-methyl-N-(2-hydroxyethyl)propionamide], 2,2′-azobis{2-methyl-N-[1,1-bis(hydroxymethyl)-2-hydroxyethyl]propionamide}, 2,2′-azobis{2-methyl-N-[1,1-bis(hydroxymethyl)ethyl]propionamide}, 2,2′-azobis(2-methylpropane), 2,2′-azobis(2,4,4-trimethylpentane), dimethyl 2,2′-azobis(2-methylpropionate), 4,4′-azobis(4-cyanopentanoic acid) and 2,2′-azobis[2-(hydroxymethyl)propionitrile].

Examples of a polymerization initiator used in the case where the curable functional group is an epoxy group include imidazoles such as melamine, imidazole, 2-methylimidazole, 2-undecylimidazole, 2-heptacylimidazole, 2-ethyl-4-ethylimidazole, 2-phenylimidazole, 2-phenyl-4-methylimidazole, 1-benzyl-2-methylimidazole, 1-benzyl-2-phenylimidazole, 1,2-dimethylimidazole, 1-cyanoethyl-2-methylimidazole, 1-cyanoethyl-2-ethyl-4-methylimidazole, 1-cyanoethyl-2-undecylimidazole, 1-cyanoethyl-2-phenylimidazole, 1-cyanoethyl-2-undecylimidazolium trimellitate, 1-cyanoethyl-2-phenylimidazolium trimellitate, 2,4-diamino-6-[2′-methylimidazolyl-(1′)]-ethyl-S-triazine, 2,4-diamino-6-[2′-undecylimidazolyl-(1′)]-ethyl-S-triazine, 2,4-diamino-6-[2′-ethyl-4′-imidazolyl-(1′)]-ethyl-S-triazine, 2,4-diamino-6-[2′-methylimidazolyl-(1′)]-ethyl-S-triazine isocyanuric acid adduct, 2-phenylimidazole isocyanuric acid adduct, 2-methylimidazole isocyanuric acid adduct, 2-phenyl-4,5-dihydroxymethylimidazole, 2-phenyl-4-methyl-5-hydroxymethylimidazole, 2,3-dihydro-1H-pyrrolo[1,2-a]benzimidazole, 4,4′-methylenebis(2-ethyl-5-methylimidazole), and 1-dodecyl-2-methyl-3-benzylimidazolium chloride;

strong organic bases and salts thereof such as 1,8-diazabicyclo(5,4,0)undecene-7 and its phenolic salt, octyl salt, p-toluenesulfonic acid salt, formic acid salt, orthophthalic acid salt or phenol-novolak resin salt, 1,5-diazabicyclo(4,3,0)nonene-5 and its phenol-novolak resin salt;
anionic initiators such as quaternary phosphonium bromides and ureas including aromatic dimethylureas and aliphatic dimethylureas;
cationic catalysts such as silanols including triphenylsilanol; and
aluminum chelate catalysts such as aluminum
tris(acetylacetone).

An energy ray for use in the micropattern-forming method according to the present invention is not particularly limited as long as it acts on the functional group in the silsesquioxane skeleton-containing compound to cure the curable composition. Examples of the energy ray include radiations such as ultraviolet rays and X-rays and electron beams. Among them, an ultraviolet ray and an electron beam are preferably used.

In the case of using an electron beam, the (meth)acrylic group can react without any polymerization initiator to cure. The present composition is preferably added a polymerization initiator depending on a combination of an active energy ray applied to the composition and a functional group as required.

When the curable functional group is a (meth)acryloyl group and the curable composition contains the polythiol compound, the curable composition may contain an acetophenone-based photoradical polymerization initiator such as 4-phenoxydichloroacetophenone, 4-t-butyl-dichloroacetophenone, 4-t-butyl-trichloroacetophenone, diethoxyacetophenone, 2-hydroxy-2-cyclohexylacetophenone, 2-hydroxy-2-methyl-1-phenylpropane-1-one, 2-hydroxy-2-phenyl-1-phenylpropane-1-one, 1-(4-dodecylphenyl)-2-hydroxy-2-methylpropane-1-one, 1-(4-isopropylphenyl)-2-hydroxy-2-methylpropane-1-one, 4-(2-hydroxyethoxy)-phenyl-(2-hydroxy-2-propyl)ketone, 1-hydroxycyclohexyl phenyl ketone or 2-methyl-1-[4-(methylthio)phenyl]-2-morpholinopropane-1;

a benzoin-based photoradical polymerization initiator such as benzoin, benzoin methyl ether, benzoin isopropyl ether,
benzoin isobutyl ether or benzyl methyl ketal;
a benzophenone-based photoradical polymerization initiator such as benzophenone, benzoylbenzoic acid, methyl benzoylbenzoate, 4-phenylbenzophenone, hydroxybenzophenone, an acrylated benzophenone, 4-benzoyl-4′-methyldiphenyl sulfide, 3,3′-dimethyl-4-methoxybenzophenone, 4,4′-dimethylaminobenzophenone, 4,4′-diethylaminobenzophenone or 3,3′,4,4′-tetra(t-butylperoxycarbonyl)benzophenone;
a thioxanthone-based photoradical polymerization initiator such as thioxanthone, 2-chlorothioxanthone, 2-methylthioxanthone, 2,4-dimethylthioxanthone, 2,4-diethylthioxanthone, 2,4-diisopropylthioxanthone, isopropylthioxanthone, 1-chloro-4-propoxythioxanthone or 2,4-dichlorothioxanthone;
a ketone-based photoradical polymerization initiator such as an α-acyloxime ester, methyl phenylglyoxylate, benzyl, 9,10-phenanthrenequinone, camphorquinone, dibenzosuberone, 2-ethylanthraquinone or 4′,4″-diethylisophthalophenone;
an imidazole-based photoradical polymerization initiator such as 2,2′-bis(2-chlorophenyl)-4,4′,5,5′-tetraphenyl-1,2′-imidazole;
an acylphosphine oxide-based photoradical polymerization initiator such as 2,4,6-trimethylbenzoyldiphenylphosphine oxide;
a carbazole-based photoradical polymerization initiator; or
a photoradical polymerization initiator such as an onium salt of a Lewis acid exemplified by triphenylphosphonium hexafluoroantimonate, triphenylphosphonium hexafluorophosphate, p-(phenylthio)phenyldiphenylsulfonium hexafluoroantimonate, 4-chlorophenyldiphenylsulfonium hexafluorophosphate and (2,4-cyclopentadiene-1-yl)[(1-methylethyl)benzene]-iron-hexafluorophosphate.

When the curable functional group is an epoxy group or when the curable functional group is an epoxy group and the curable composition contains the vinyl ether group-containing compound, the curable composition may contain a cationic photopolymerization initiator such as a sulfonium salt including triphenylsulfonium hexafluoroantimonate, an iodonium salt, a diazonium salt or an allene-ion complex.

These polymerization initiators may be used alone or in combination of two or more kinds thereof. The amount of the polymerization initiator used is preferably 0.01 to 10 parts by mass per 100 parts by mass of the curable composition.

The curable composition according to the present invention may contain an additive such as a viscosity modifier, a dispersant, or a surface conditioner in addition to the polymerization initiator and the curing agent. In that case, the amount of the additive used is preferably 30 parts by mass or less per 100 parts by mass of the curable composition. When the amount of the additive used is excessively large, the micropattern which is obtained using the curable composition according to the present invention is likely to have poor etching performance.

The curable composition according to the present invention may further contain a solvent or the like for the purpose of enhancing coating properties as required. As a dilution solvent, the solvent which is used in the production reaction of the silsesquioxane skeleton-containing compound may be used as it is. After the reaction solvent is distillated off under reduced pressure, dilution with another solvent can be carried out.

Examples of the solvent include ketone-based solvents such as methyl isobutyl ketone; aromatic hydrocarbon solvents such as toluene and xylene; ester-based solvents such as ethyl acetate, butyl acetate and propylene glycol monomethyl ether acetate; and alcohol-based solvents such as 2-propanol, butanol, hexanol propylene glycol mono-n-propyl ether and ethylene glycol monoethyl ether.

[Method for Forming Micropattern with a Size of 10 μm or Less]

A method for forming a micropattern with a size of 10 μm or less using the curable composition for transfer materials according to the present invention is described below. The term “micropattern with a size of 10 μm or less” as used herein means a pattern formed in a die having concave and convex lines with a width of 10 μm or less, that is, a pattern in which the sum of the width of the concave line and that of the convex line is 10 μm or less.

The method for forming a micropattern with a size of 10 μm or less according to the present invention comprises a step of applying the curable composition for transfer material according to the present invention on a substrate, a step of pressing a die to the curable composition for transfer materials, a step of curing the curable composition for transfer materials by irradiation with an active energy ray and/or heating and a step of removing the die from the cured curable composition for transfer materials. Each of the steps is described below.

### <1. Applying Step>

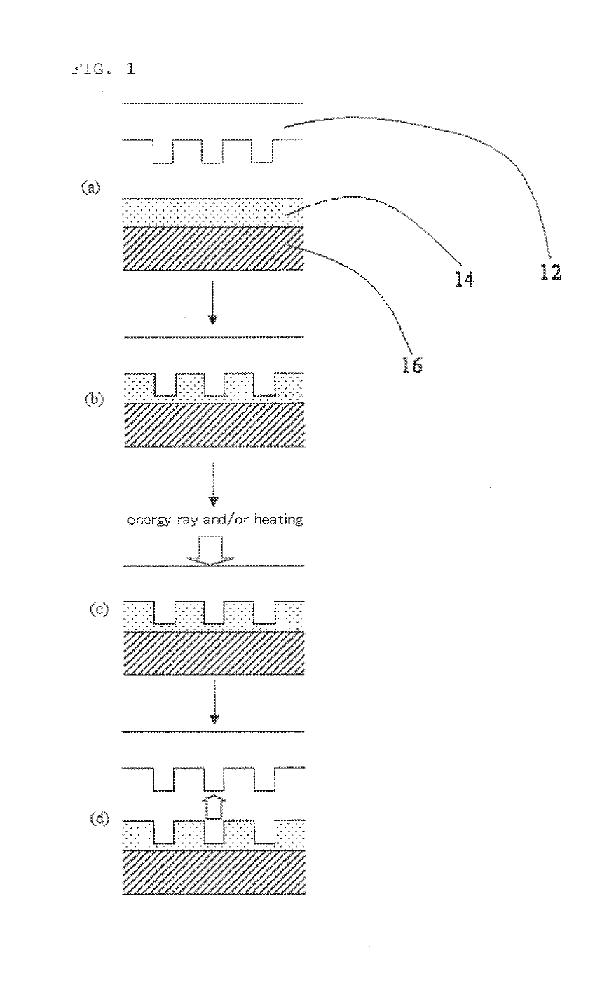

A process for applying the curable composition to the substrate is not particularly limited and, for example, a process such as spin coating or dip coating can be used. The following process is preferably used: a process capable of forming a film of the curable composition for transfer materials on the substrate such that the film has a uniform thickness. FIG. 1(a) shows a state in which the substrate is applied with the curable composition according to the present invention.

The term “substrate” as used herein means a matter consisting of a base such as a glass plate and a layer where a pattern of a magnetic film and/or a protective film is formed, the layers being disposed on the base.

### <2. Transferring and Curing Steps>

The micropattern can be formed by pressing (transferring) the die, on which a fine pattern has been already formed, to a coated film. After pressing the die to the coated film, in order to cure the curable composition, curing by the active energy ray or thermal curing is carried out. Alternatively, the both methods can be combined to carry out irradiation with the active energy ray under heating. FIGS. 1(b) and 1(c) show the step of pressing the die to the curable composition according to the present invention applied to the substrate and the step of curing the composition by irradiation with active energy ray and/or heating, respectively.

A material for the die is not particularly limited. In the case of curing the curable composition with an active energy ray such as an ultraviolet ray, the die is preferably made of resin which transmits the active energy ray, glass or quartz, because even if the substrate transmits no active energy ray, the micropattern can be formed in such a manner that the active energy ray is applied to the curable composition in a direction from the die to the coated film of the curing composition and thereby the curable composition is cured. When the substrate is a transparent substrate or the like which transmits the active energy ray, curing is carried out by usually applying the active energy ray in a direction from the transparent substrate to the coated film of the curable composition.

An atmosphere used during pressing the die or subsequent applying heat or the energy ray is not particularly limited. They are preferably carried out under vacuum in order to prevent bubbles from remaining in the cured curable composition. When the curable functional group is a carbon-carbon double bond such as a (meth)acryloyl group, an allyl group or a vinyl group, it is preferred that pressing the die and subsequent heating or the energy ray irradiation are carried out in vacuum, because polymerization can be prevented from being inhibited by oxygen.

### <3. Die-Removing Step>

After the coated film which is made of the curable composition according to the present invention is cured, the die is removed from the coated film. The micropattern may be heated subsequently to the removal of the die in order to enhance its heat resistance and physical strength. A process for the heating is not particularly limited. It is preferable that, the formed pattern is gradually heated to a temperature which is set at the glass transition temperature of the coated film or less in order that the pattern is not broken, and that the upper limit of the heating temperature is set at 250° C. for the purpose of preventing the thermal decomposition of the coated film.

The micropattern with a size of 10 μm or less is formed as described above. The micropattern is a substance resulting from the curing of the curable composition for transfer materials according to the present invention and has high selectivity on etching rates regarding a fluorine-based gas and an oxygen gas. Therefore, a micropattern formed by the method for forming a micropattern with a size of 10 μm or less has high resistance to an etching gas; hence, the degree of etching can be readily controlled. The micropattern has low resistance to gas used to remove the micropattern and therefore can be readily removed. Accordingly, the micropattern acts as a good resist and therefore can be used for various applications including semiconductors and magnetic recording media.

The curable composition for transfer materials according to the present invention can be used for various applications including magnetic recording media as described above. An application of a magnetic recording medium is as follows: a micropattern is formed on the magnetic recording medium by using the micropattern of the cured film formed by the above micropattern-forming method. For example, a magnetic film in the magnetic recording medium is partly removed or demagnetized through the micropattern, whereby a finely patterned magnetic recording medium can be manufactured. A process therefor is described below.

### (1. Bottom Blanking)

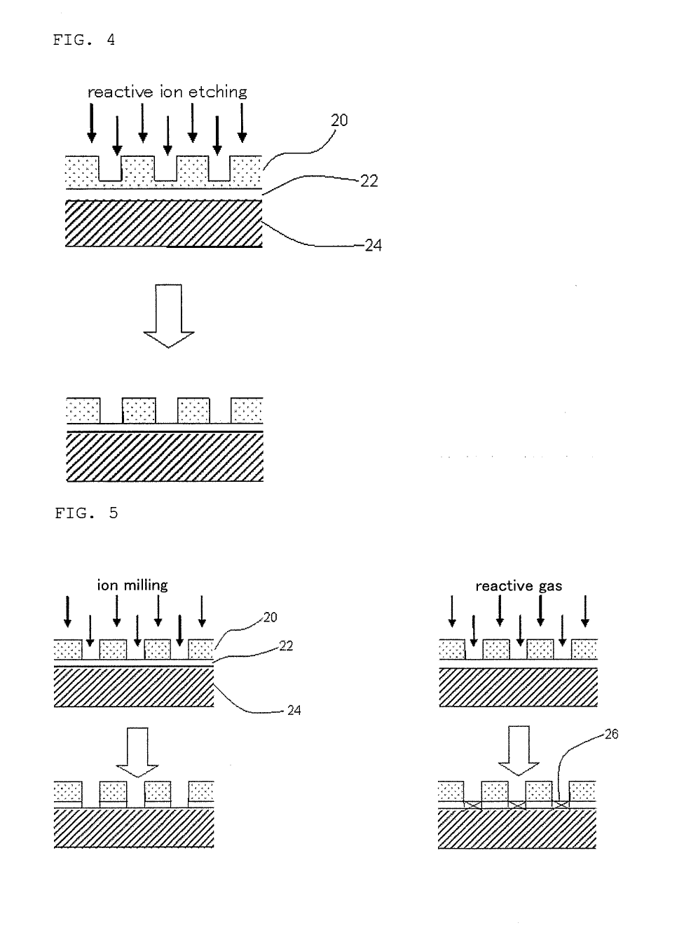

A concave portion of the micropattern is etched by reactive ion etching (RIE, or referred to as ion milling), whereby a surface of the magnetic film is exposed. FIG. 4 schematically shows this step.

### (2. Partial Removal or Demagnetization of Magnetic Film)

A magnetic portion exposed by ion milling is etched or a exposed magnetic portion is demagnetized with a reactive gas. The micropattern should have resistance to ion milling and the reactive gas. FIG. 5 schematically shows this step. An example of a process for demagnetizing the magnetic portion is a process which is disclosed in Japanese Unexamined Patent Application Publication No. 2007-273067 and in which the magnetic portion is amorphized in such a manner that atoms such as silicon, boron, fluorine, phosphorus, tungsten, carbon, indium, germanium, bismuth, krypton or argon are implanted into the magnetic portion by an ion beam technique.

Then, the micropattern remaining on the magnetic film is removed, whereby the magnetic recording medium is obtained.

By incorporating the magnetic recording medium which is produced as described above into a magnetic recording/reproducing device, a magnetic recording/reproducing device having a significantly increased recording density as well as having the same or more recording/reproducing performance than that of conventional magnetic recording/reproducing devices can be produced.

### EXAMPLES

The present invention is further described in detail with reference to examples. But the present invention is not limited to them. The term “part(s)” used in the below examples represents “part(s) by mass” unless otherwise specified.

### Example 1

Into a three-necked flask equipped with a thermometer and a cooling tube, 1.0 g (0.98 mmol) of octakis(dimethylsilyloxy)silsesquioxane (PSS-Octakis(dimethylsilyloxy)substituted produced by Aldrich), 1.98 g (15.7 mmol, 2.0 times by mole on the basis of Si—H group) of allyl methacrylate (produced by Mitsubishi Gas Chemical) and 30 ml of toluene were added, followed by stirring at room temperature under an Ar stream. To the mixture, 0.093 g (the weight of platinum metal was 1,000 ppm on the basis of the weight of the charged raw materials) of a 2% solution (produced by GELEST INC.) of a platinum-divinyltetramethyldisiloxane complex in xylene was slowly added. After stirring at room temperature for 2 hours, toluene was vacuum-distilled off (the percentage of a skeleton of formula (1) in the silsesquioxane skeleton-containing compound in a curable composition: 20.6%). A product thereby obtained was dissolved in propylene glycol monomethyl ether acetate such that a solution with a solid content concentration of 10% was obtained.

3 Part of a photoradical polymerization initiator, 2-hydroxy-2-methyl-1-phenylpropane-1-one (Darocure 1173 produced by Ciba Specialty Chemicals Inc.) with respect to 100 parts of the solid content, was added to and was dissolved in the obtained solution, followed by filtration with a 0.2 μm filter, whereby a curable composition was obtained. On a glass substrate set in a spin coater, 0.5 ml of the curable composition was dropped. The glass substrate was rotated at 500 rpm for 5 seconds, at 3,000 rpm for 2 seconds and then at 5,000 rpm for 20 seconds, whereby a thin film was formed on the glass substrate. The glass substrate applied with the curable composition was placed under a nitrogen stream and was irradiated with an ultraviolet ray. The obtained cured thin film was measured for reactive ion etching rate using a CF₄ gas and oxygen.

### (Procedure for Measuring Etching Rate)

A piece of glass was attached to the cured thin film. The cured thin film was etched in a reactive ion etching system under conditions below. The glass piece was removed. The difference in level between an etched portion of the thin film and a portion of the thin film that was protected by the glass substrate was measured.

Etching rate(nm/s)=difference in level(nm)÷processing time(s)

### Reactive Ion Etching Conditions

### (Fluorine-Based Gas)

Etching gas: carbon tetrafluoride

Pressure: 0.5 Pa

Gas flow rate: 40 sccm

Plasma voltage: 200 W

Bias voltage: 20 W

Processing time: 30 s

### (Oxygen)

Etching gas: oxygen

Pressure: 0.5 Pa

Gas flow rate: 40 sccm

Plasma voltage: 200 W

Bias voltage: 20 W

Processing time: 600 s

### Comparative Example 1

Into a three-necked 100-ml flask equipped with a reflux condenser, a thermometer, a stirrer and a serum cap, 1.0 g (4.2 mmol) of cyclic hydrogen siloxane (LS-8600 produced by Shin-Etsu Chemical), 4.16 g (33.3 mmol) of allyl methacrylate and 30.0 ml of toluene were added, followed by stirring at room temperature under an Ar stream. To the mixed solution, 0.0987 g (1.0% by mole) of a 2% solution (produced by GELEST INC.) of a platinum-divinyltetramethyldisiloxane complex in xylene was slowly added using a syringe, followed by stirring at room temperature. After stirring at room temperature for 2 hours, toluene was vacuum-distilled off. An obtained product was dissolved in propylene glycol monomethyl ether acetate such that a solution with a solid content concentration of 10% was obtained.

3 Parts of a photoradical polymerization initiator, 2-hydroxy-2-methyl-1-phenylpropane-1-one (Darocure 1173 produced by Ciba Specialty Chemicals Inc.) with respect to 100 parts of the solid content, were added to and was dissolved in the obtained solution, followed by filtration with a 0.2 μm filter, whereby a curable composition was obtained. On a glass substrate set in a spin coater, 0.5 ml of the curable composition was dropped. The glass substrate was rotated at 500 rpm for 5 seconds, at 3,000 rpm for 2 seconds and then at 5,000 rpm for 20 seconds, whereby a thin film was formed on the glass substrate. The glass substrate applied with resin was placed under a nitrogen stream and was irradiated with an ultraviolet ray. An obtained resin thin film was measured for reactive ion etching rate using a CF₄ gas and oxygen.

The reactive ion etching rates of the respective gases used in Example 1 and Comparative Example 1 are shown in a table below.

TABLE 1

| | Example 1 | Comparative Example 1 |
|---|---|---|
| O₂ etching rate (nm/s) | 0.37 | 1.49 |
| CF₄ etching rate (nm/s) | 1.33 | 1.16 |

The etching rate of a cured product, obtained from the curable composition of Example 1, with oxygen is low, which shows high resistance to oxygen etching. The etching rate of the cured product of Example 1 with CF₄ is higher than that of Comparative Example 1, which shows that the product has extremely high selectivity on etching rates and therefore is suitable for use as a resist.

### Example 2

Into a three-necked flask equipped with a thermometer and a cooling tube, 1.0 g (0.98 mmol) of octakis(dimethylsilyloxy)silsesquioxane (PSS-Octakis(dimethylsilyloxy)substituted produced by Aldrich), 1.98 g (15.7 mmol, 2.0 times by mole on the basis of Si—H group) of allyl methacrylate (produced by Mitsubishi Gas Chemical) and 30 ml of toluene were added, followed by stirring at room temperature under an Ar stream. To the mixture, 0.093 g (the weight of platinum metal was 1,000 ppm on the basis of the weight of the charged raw materials) of a 2% solution (produced by GELEST INC.) of a platinum-divinyltetramethyldisiloxane complex in xylene was slowly added. After stirring at room temperature for 2 hours, toluene was vacuum-distilled off (the percentage of a skeleton of formula (1) in the silsesquioxane skeleton-containing compound in a curable composition: 20.6%). A product thereby obtained was dissolved in propylene glycol monomethyl ether acetate such that a solution with a solid content concentration of 5% was obtained.

3 Parts of a photoradical polymerization initiator, 2-hydroxy-2-methyl-1-phenylpropane-1-one (Darocure 1173 produced by Ciba Specialty Chemicals Inc.) with respect to 100 parts of the solid content, were added to and was dissolved in the solution, followed by filtration with a 0.2 μm filter, whereby a curable composition was obtained. On a glass substrate set in a spin coater, 0.5 ml of the curable composition was dropped. The glass substrate was rotated at 500 rpm for 5 seconds, at 3,000 rpm for 2 seconds and then at 5,000 rpm for 20 seconds, whereby a thin film was formed on the glass substrate.

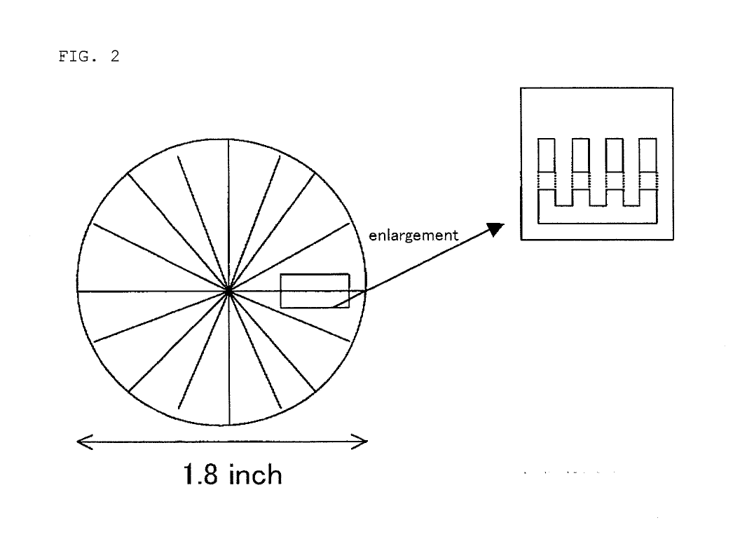

Next, a die which was made of quartz glass and which had been patterned with a concave and convex shape along the radial direction as shown in FIG. 2 was provided on a surface of the curable composition film formed on the glass substrate (which was circular) in such a manner that the patterned surface was directed downward. The concave portions had a depth of 150 nm. The assembly was set in a UV nanoimprint press apparatus, ST50 (manufactured by Toshiba Machine Co., Ltd.), pressed by the die and irradiated with ultraviolet light having a wavelength of 365 nm and an intensity of 6.5 mW. After the disk underlying the die was taken out of the press apparatus and the die was then removed therefrom, the film on the glass disk was observed, which showed that there were no defects such as pattern defects and ununiform coated film.

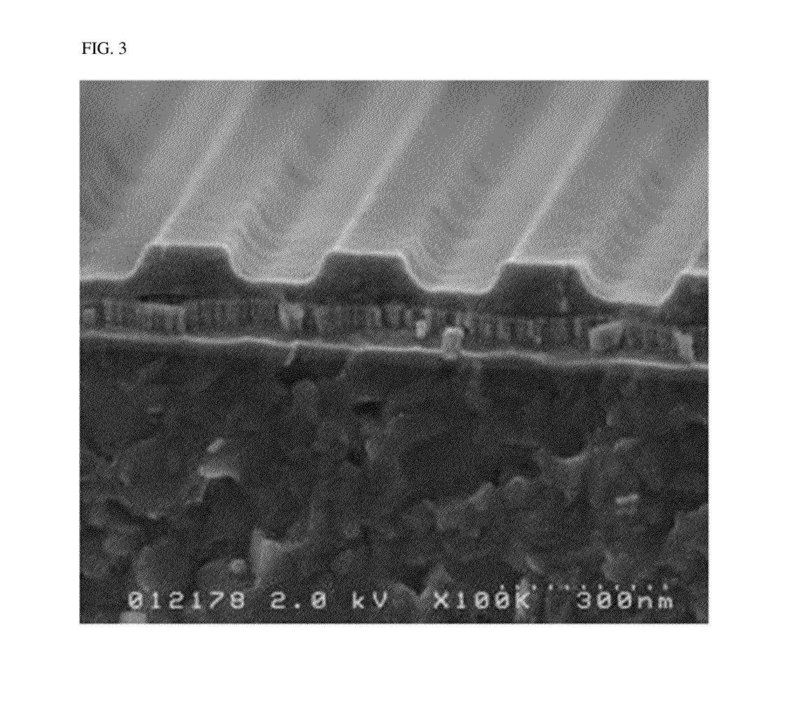

FIG. 3 shows results obtained by analyzing a cross section of the substrate by SEM which had a transferred pattern.

### Example 3

Into a three-necked flask equipped with a thermometer and a cooling tube, 1.0 g (0.98 mmol) of octakis(dimethylsilyloxy)silsesquioxane (PSS-Octakis(dimethylsilyloxy)substituted produced by Aldrich), 0.975 g (7.84 mmol, 1.0 times by mole on the basis of Si—H group) of 1,2-epoxy-4-vinylcyclohexane (CELLOXIDE 2000 produced by Daicel Chemical Industries Ltd.) and 5 ml of toluene were added, followed by stirring at room temperature under an Ar stream. To the mixture, 0.093 g (the weight of platinum metal was 1,000 ppm on the basis of the weight of the charged raw materials) of a 2% solution (produced by GELEST INC.) of a platinum-divinyltetramethyldisiloxane complex in xylene was slowly added. After stirring at room temperature for 2 hours, toluene was vacuum-distilled off (the percentage of a skeleton of formula (1) in the silsesquioxane skeleton-containing compound in a curable composition: 20.7%). A product thereby obtained was dissolved in propylene glycol monomethyl ether acetate such that a solution with a solid content concentration of 10% was obtained.

1 Part of a photoradical polymerization initiator, triphenylsulfonium hexafluoroantimonate (CPI-101A produced by San-Apro Ltd.) with respect to 100 parts of the solid content, was added to and was dissolved in the obtained solution, followed by filtration with a 0.2 μm filter, whereby a curable composition was obtained. On a glass substrate set in a spin coater, 0.5 ml of the curable composition was dropped. The glass substrate was rotated at 500 rpm for 5 seconds, at 3,000 rpm for 2 seconds and then at 5,000 rpm for 20 seconds, whereby a thin film was formed on the glass substrate. The glass substrate applied with the curable composition was placed under a nitrogen stream and was irradiated with an ultraviolet ray. The obtained cured thin film was measured for reactive ion etching rate using a CF₄ gas and oxygen in the same manner as that described in Example 1.

TABLE 2

| | Example 3 |
|---|---|
| O₂ etching rate (nm/s) | 0.70 |
| CF₄ etching rate (nm/s) | 1.23 |

Results obtained from Examples 1 and 3 suggest that a resist obtained from a curable composition, according to the present invention, containing a functional group that is a methacryloyl group is superior in selectivity on etching rate to a resist obtained from a curable composition, according to the present invention, containing a functional group that is an epoxy group.

What is claimed is:

1. A method for forming a micropattern, comprising:
a step of applying a curable composition for transfer materials comprising a silsesquioxane skeleton-containing compound on a substrate;
a step of pressing a die to the curable composition for transfer materials;
a step of curing the curable composition for transfer materials; and
a step of removing the die from the cured curable composition for transfer materials,
wherein the silsesquioxane skeleton-containing compound has, in its molecule,
a curable functional group and
a silsesquioxane skeleton represented by the following formula (1)

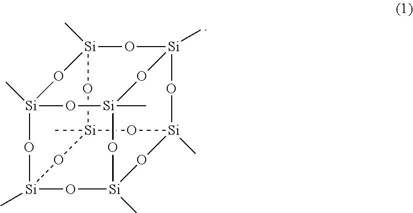

2. The micropattern-forming method according to claim 1, wherein the silsesquioxane skeleton occupies 5% or more of the molecular weight of the silsesquioxane skeleton-containing compound.

3. The micropattern-forming method according to claim 1, wherein the silsesquioxane skeleton-containing compound is produced by subjecting a cage-type silsesquioxane (A) having a Si—H group and the silsesquioxane skeleton represented by formula (1), and a compound (B) having the curable functional group and a carbon-carbon unsaturated bond other than the curable functional group to hydrosilylation reaction.

4. The micropattern-forming method according to claim 3, wherein the cage-type silsesquioxane (A) is represented by the following formula (2): 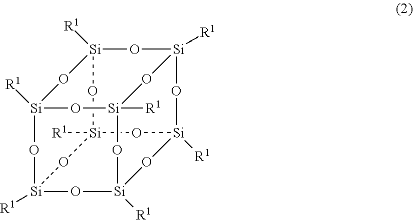
wherein R¹ represents a hydrogen atom or HR²R³SiO— (R² and R³ independently represent an aromatic hydrocarbon group or an aliphatic group having 1 to 10 carbon atoms), and plural R¹ may be the same as or different from each other.

5. The micropattern-forming method according to claim 1, wherein the curable functional group is an active energy ray-curable functional group.

6. The micropattern-forming method according to claim 5, wherein the active energy ray-curable functional group is at least one selected from the group consisting of a (meth)acryloyl group and an epoxy group.

7. The micropattern-forming method according to claim 3, wherein the compound (B) is at least one selected from the group consisting of the following compound (a), compound (b) and compound (c): 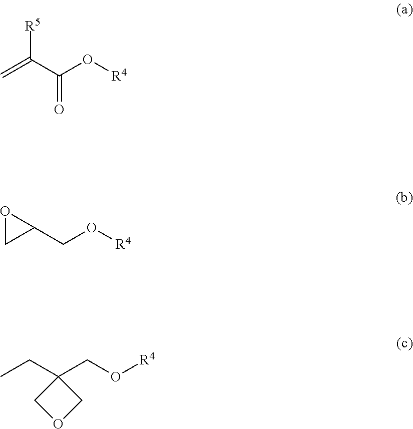
wherein R⁴ is any one of the following structures and R⁵ is hydrogen or a methyl group: 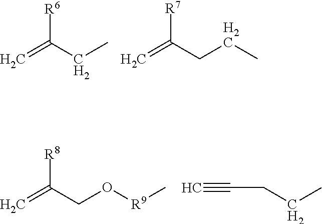
wherein R⁶ to R⁸ are hydrogen or a methyl group and R⁹ is an alkylene group having 2 to 8 carbon atoms.

8. The micropattern-forming method according to claim 3, wherein the compound (B) is 1,2-epoxy-4-vinylcyclohexane.

9. The micropattern-forming method according to claim 1, comprising a curing agent or a polymerization initiator.

10. The micropattern-forming method according to claim 9, wherein the curable functional group is an epoxy group and the curing agent is an acid anhydride.

11. The micropattern-forming method according to claim 6, further comprising a polythiol compound, wherein the curable functional group is a (meth)acryloyl group.

12. The micropattern-forming method according to claim 6, further comprising a compound having a vinyl ether group, wherein the curable functional group is an epoxy group.

13. The micropattern-forming method according to claim 1, wherein the micropattern is a micropattern with a size of 10 μm or less.

14. The micropattern-forming method according to claim 1, wherein the step of curing the curable composition for transfer materials is by heating.

15. The micropattern-forming method according to claim 1, wherein the step of curing the curable composition for transfer materials is by irradiation with an active energy ray.

16. The micropattern-forming method according to claim 15, wherein the active energy ray is irradiated in a direction from the die to a coated film of the curable composition for transfer materials.

17. The micropattern-forming method according to claim 15, wherein the substrate is a transparent substrate and the active energy ray is irradiated in a direction from the transparent substrate to a coated film of the curable composition for transfer materials.

18. A method for manufacturing a finely patterned magnetic recording medium, wherein the substrate comprises a base and a magnetic film disposed thereon and the magnetic film is partly removed or demagnetized using a micropattern formed by the method according to claim 14.

19. A method for manufacturing a finely patterned magnetic recording medium, wherein the substrate comprises a base and a magnetic film disposed thereon and the magnetic film is partly removed or demagnetized using a micropattern formed by the method according to claim 15.
